(19) United States
(12) Patent Application Publication
(10) Pub. No.: US 2003/0080127 A1
(43) Pub. Date: May 1, 2003

(54) Removable tub

(76) Inventors: Xavier Gibert, Chassieu (FR); Francis Lepage, Dommartin (FR); Bertrand Barre, Lapeyrouse (FR)

Correspondence Address: OLIFF & BERRIDGE, PLC, P.O. BOX 19928, ALEXANDRIA, VA, 22320, US

(21) Appl. No.: 10/266,674

(22) Filed: Oct. 9, 2002

Related U.S. Application Data
(60) Provisional application No. 60/328,112, filed on Oct. 11, 2001.

(51) Int. Cl. B65D 21/02; A47G 19/00; A23B 4/00

(52) U.S. Cl. 220/23.4; 220/694; 220/574; 426/115

(57) ABSTRACT

This is a tub intended to contain a food product, which tub is associated with a fixing means for mounting on the edge of a plate. The tub and the fixing means are made as a single piece, by molding or by injection-molding.

### BACKGROUND OF THE INVENTION

The present invention relates to a tub or portion cup intended to contain a food product, this tub being associated with a fixing means for mounting it on the edge of a plate or of a dish.

Such tubs are generally used during cocktail parties or fast food meals so as, for example, to be able to season the food served on the plate or the dish. The user can thus hold the plate and the seasoning in one hand without the seasoning mixing with the contents of the plate unintentionally.

### DESCRIPTION OF THE PRIOR ART

Tubs of this type usually encountered are held fast on the edge of the plate by being attached thereto by fitting into a fixing means which is itself immobilized on the edge of the plate. The tub is therefore not very stable and there is a risk of it falling over and dropping onto the ground or onto the user. In addition, the fixing means usually encountered make the assembly bulky on the edge of the plate and this further increases the risk of droppage.

### SUMMARY OF THE INVENTION

It is a particular object of the present invention to alleviate these drawbacks by providing a tub which can be immobilized in a simple, effective and inexpensive way.

To this end, according to the invention a tub of the kind in question is essentially characterized in that the tub and the fixing means are produced as a single piece by molding or injection-molding.

Thus, by virtue of these arrangements, there is no risk of the tub becoming detached from the fixing means and the risks of poor use are thus limited.

According to a preferred form of the invention, the tub comprises a body which produces the container for the food product and which has a bottom and walls extending from this bottom, and the fixing means extend substantially under the bottom, on the outside of the tub. The bulk of the tub under the edge of the plate is thus small because the tub and its fixing means are compact.

As an alternative, the fixing means comprises a foot extending substantially in a plane and having a separation from the bottom of the body, so as to allow an edge of a plate or of a dish to be clipped in between the bottom and the foot. The user can thus easily remove the tub having used up all its contents, and replace it with another tub.

In yet another alternative form, the spacing extends under the body over sufficient depth to allow said body to be positioned inside the plate or the dish. The tub thus projects outside the plate very little.

As a preference, the spacing can be altered elastically so as to suit edges of different thicknesses. The tub can thus be used in a multi-purpose way.

Also as a preference, the foot is connected to the bottom by a leg the dimensions of which are small by comparison with the dimensions of the body.

As an alternative, the foot comprises first projections which project toward the bottom of the tub.

In yet another alternative, the bottom of the tub comprises second protrusions which project toward the foot and which are offset from the first protrusions, so as to grip the edge of the plate or dish.

As yet another preference, the foot adopts the shape of a flat cheek.

In a preferred form, the foot is inscribed inside the surface delimited by the projection of the body onto a horizontal plane, on an axis perpendicular to the bottom of the body. The bulk of the tub is thus further reduced.

### BRIEF DESCRIPTION OF THE DRAWINGS

Other features and advantages of the invention will become apparent through the following description of one of its embodiments, which is given by way of nonlimiting example with reference to the appended drawings, in which:

FIG. 1 is a side view of the tub equipped with a fixing means according to the present invention; and

FIG. 2 is a perspective view of the tub of FIG. 1, mounted on the edge of a plate or dish.

### DESCRIPTION OF THE PREFERRED EMBODIMENTS

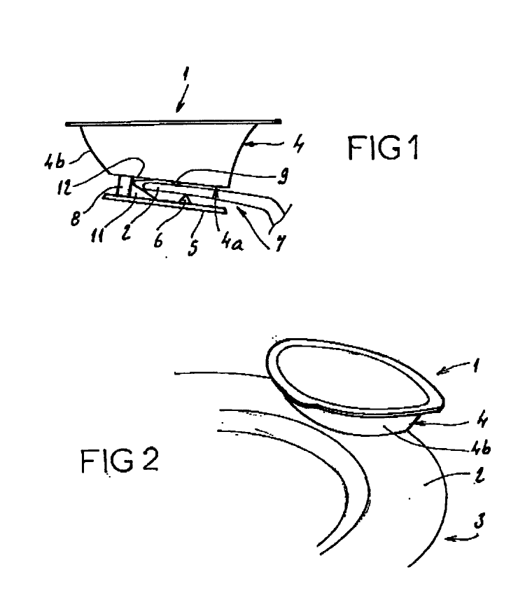

The tub 1 depicted in FIGS. 1 and 2 is intended to be attached and immobilized removably on an edge 2 of a plate 3.

The tub 1 comprises a body 4 in which the food product is contained, this body consisting of a bottom 4a from which walls 4b extend.

The tub 1 is immobilized on the edge of the plate 3 by by a fixing means 5. According to an essential feature of the invention, this fixing means 5 is made as a single piece with the tub 1, for example by molding or injection-molding.

As a preference, the fixing means 5 extend substantially under the bottom 4a of the tub 1 while at the same time being situated on the outside of this tub.

As shown more specifically in FIG. 1, the fixing means 5 adopts the form of a foot which extends substantially in a plane and which has a separation 7 from the bottom 4a of the body 4 of the tub 1. This separation is tailored to allow the edge 2 of the plate 3 to be clipped in between the foot 5 and the bottom 4a of the tub 1.

The bottom 4a of the tub therefore plays a part in immobilizing the tub since the edge 2 of the plate is trapped directly between this bottom and the foot 5.

The separation 7 delimited between the bottom 4a and the foot 5 extends over sufficient depth for the edge 2 of the plate 3 to be introduced over a length that allows the body 4 to be positioned practically entirely inside the boundaries of the plate or of the dish.

The foot 5 is situated under the bottom 4a of the tub 1 by means of a leg 8. This leg 8 projects substantially at right angles to the plane defined by the bottom 4a and extends over a length which is small by comparison with the overall dimensions of the tub 1. In practice, the length of the leg 8 defines the height of the space 7. Furthermore, the depth of the space 7 is defined by the end of the edge 2 of the plate 3 coming into abutment against the leg 8.

The foot 5 is made in the form of a flat element the thickness of which is thin enough to be elastically deformable so that the separation can be altered elastically to suit plate 3 edges 2 of different thicknesses.

As a preference, the tub 1 and foot 5 are obtained by injection molding of a plastic. The foot 5 is in the form of a flat cheek the external dimensions of which substantially correspond to those of the bottom 4a of the tub 1. Thus, the foot 5 is inscribed inside the surface defined by the projection of the body 4 onto a horizontal plane, this projection being done on an axis perpendicular to the bottom of this body. It will thus be understood that the foot 5 is of very small bulk because it is situated under the tub 1 without protruding laterally outside the cylinder in which the tub 1 is inscribed. Having been immobilized on the plate, the tub 1 thus protrudes only very slightly outside the boundaries of this plate. It protrudes by an amount that corresponds to the distance separating the leg 8 from the extreme edge of the walls 4b of the body 4.

In addition, since the foot 5 is situated under a body 4, the center of gravity of the tub 1 is not displaced, and this means that the assembly on the edge of the plate is very stable.

In addition, in order to make the edge 2 easier to clip between the foot 5 and the bottom 4a of the body 4, protrusions project into the spacing 7. Thus, the foot 5 has first protrusions 6 which extend toward the bottom 4a of the tub 1 and this bottom 4a of the tub 1 itself has second protrusions 9 directed in the opposite direction to the first protrusions 6, toward the foot 5. These protrusions are offset from one another to make attachment to the edge 2 easier.

The stability with which the tub 1 is attached to the edge 2 may be further enhanced by wedging the free end of the edge 2 of the plate 3 between two inclined surfaces 11 and 12. These inclined surfaces project from the leg 8 inside the spacing 7, defining a wedge. In the embodiment depicted in the figures, the foot 5 extends substantially parallel to the bottom 4a of the body 4 of the tub 1. However, as an alternative, the foot 5 may converge toward the bottom 4a in order to reduce the entry opening of the space 7 via which the edge 2 of the plate is introduced. The clip defined by the bottom 4a and the foot 5 then exerts an even stronger force on the edge 2 of the plate.

Of course, even though the tub and the foot 5, which are depicted in FIGS. 1 and 2, are of substantially oval shape in cross section, any other shape is conceivable without departing from the scope of the present invention.

The presence of the foot 5 under the bottom 4a of the tub 1 advantageously allows this foot to be concealed when the tub 1 is positioned on the plate 3. The appearance is therefore better.

By virtue of the shape of the foot 5, it is also possible simply to place the tub 1 on any support such as a table. The user is therefore not obliged to position the tub 1 on the edge of a plate or of a dish in order to consume the contents of this tub.

The foot 5 here adopts the form of a solid cheek. However, as an alternative, this foot may be of annular shape or of any other substantially flat shape.

1. A tub intended to contain a food product, this tub being associated with a fixing means for mounting it on the edge of a plate or of a dish, the tub and the fixing means being made as a single piece, by molding or injection-molding.

2. The tub as claimed in claim 1 and which comprises a body which produces the container for the food product and which has a bottom and walls extending from the bottom, and wherein the fixing means extend substantially under the bottom, on the outside of the tub.

3. The tub as claimed in claim 2, wherein the fixing means comprises a foot extending substantially in a plane and having a separation from the bottom of the body, so as to allow an edge of a plate or of a dish to be clipped in between the bottom and the foot.

4. The tub as claimed in claim 3, wherein the spacing extends under the body over sufficient depth to allow said body to be positioned inside the plate or the dish.

5. The tub as claimed in claim 4, wherein the spacing can be altered elastically so as to suit edges of different thicknesses.

6. The tub as claimed in claim 5, wherein the foot is connected to the bottom by a leg the dimensions of which are small by comparison with the dimensions of the body.

7. The tub as claimed in claim 6, wherein the foot comprises first projections which project toward the bottom of the tub.

8. The tub as claimed in claim 7, wherein the bottom of the tub comprises second protrusions which project toward the foot and which are offset from the first protrusions, so as to grip the edge of the plate or dish.

9. The tub as claimed in claim 8, wherein the foot adopts the shape of a flat cheek.

10. The tub as claimed in claim 9, wherein the foot is inscribed inside the surface delimited by the projection of the body onto a horizontal plane, on an axis perpendicular to the bottom of the body.
